(19) United States
(12) Patent Application Publication
(10) Pub. No.: US 2016/0101542 A1
(43) Pub. Date: Apr. 14, 2016

(54) Method for Manufacturing Composite Material

(71) Applicant: TEIJIN LIMITED, Osaka-shi, Osaka (JP)

(72) Inventors: Kazunari Kosaka, Tokyo (JP); Takuro Kitamura, Tokyo (JP); Yasuyuki Kondo, Matsuyama-shi (JP); Daisuke Kobayashi, Matsuyama-shi (JP)

(73) Assignee: Teijin Limited, Osaka-shi, Osaka (JP)

(21) Appl. No.: 14/890,944

(22) PCT Filed: Sep. 19, 2013
(86) PCT No.: PCT/JP2013/076167

§ 371 Date: Nov. 13, 2015

(30) Foreign Application Priority Data
May 15, 2013 (JP) 2013-103099

(51) Int. Cl. B29C 43/00; C08L 67/02

(52) U.S. Cl. CPC B29C 43/003; C08L 67/02; B29K 2067/006

(57) ABSTRACT

Provided is a method for manufacturing a composite material including peforming press molding a fiber matrix structure including reinforcing fibers and a matrix resin which mainly includes a polyester-based resin and includes an aromatic polycarbonate resin and. Furthermore, it is preferred that the polyester-based resin is a polyester copolymer and includes a terephthalic acid component and an isophthalic acid component. In addition, it is preferred that the press molding is cold pressing in which a die temperature is 170° C. or lower; that the reinforcing fibers are carbon fibers or fibers mainly including discontinuous fibers; and furthermore, that the discontinuous fibers are randomly oriented in the structure.

### TECHNICAL FIELD

The present invention relates to a method for manufacturing a composite material, and in more detail, the present invention relates to a method for manufacturing a composite material including reinforcing fibers and a matrix, the composite material being excellent in high physical properties and surface appearance.

### BACKGROUND ART

Fiber-reinforced composite materials are widely adopted as a material that is lightweight and excellent in high physical properties because fragility of a matrix can be reinforced with fibers having high strength.

However, molded articles including only a synthetic resin or a metal can be molded easily and quickly by injection molding or press molding, whereas fiber-reinforced composite materials encountered such a problem that moldability, particularly smoothness on the composite material surface, is hardly ensured due to the presence of reinforcing fibers with poor fluidity contained therein.

In particular, in the case of using a thermosetting resin for the matrix resin, in addition to the matter that it takes a time for integrating the matrix resin with fibers, a time for setting the matrix resin was also needed. Then, though fiber-reinforced composite bodies using a thermoplastic resin in place of the conventional thermosetting resin have been attracting attention, there was encountered such a problem that in general, the resin viscosity during the process is high as compared with the thermosetting resin, and thus, it takes a more time for impregnating the fibers with the resin.

As a method for solving these problems, for example, in the thermoplastic stamping molding method, there is disclosed a method in which chopped fibers having been previously impregnated with a resin are put into a die, and the fibers and the resin are allowed to flow within the die, thereby obtaining a product shape (see Patent Document 1 and the like). However, since it is required to secure high fluidity within the die, there were encountered such problems that unevenness is liable to be generated on the surface appearance, and that control is difficult.

In addition, there is also proposed a technology of subjecting thermoplastic resin pellets including reinforcing fibers to injection molding (see Patent Document 2 and the like); however, there was encountered such problems that the length of the pellet is an upper limit of the fiber length in the production, and that the reinforcing fibers are cut during the kneading process, and thus, thorough reinforcing effect and physical properties are not obtained. Furthermore, all of the both methods as described above encountered such a problem that the fibers are apt to be oriented, and the reinforcing effect presents strongly only in one direction, and thus, an isotropic material is hardly obtained.

Then, Patent Document 3 discloses a production method of press molding a fiber matrix structure including reinforcing fibers and a thermoplastic resin, and specifically, a polyamide resin or the like is used as the matrix resin. However, in the case of using a usual resin as the matrix resin, for example, if importance is attached to surface appearance, the physical properties are lowered, so that any composite materials capable of simultaneously satisfying reciprocal requirements were not obtained.

(Patent Document 1) JP-A-H11-81146

(Patent Document 2) JP-A-H9-286036

(Patent Document 3) JP-A-2011-178890

### SUMMARY OF INVENTION

### Problems to Be Solved by Invention

The present invention is to provide a method for manufacturing a composite material including fibers and a resin, which has high high-temperature physical properties and ensures a smooth surface appearance.

### Means for Solving the Problems

A method for manufacturing a composite material according to the present invention includes performing press molding of a fiber matrix structure including reinforcing fibers and a matrix resin which mainly includes a polyester-based resin and which includes an aromatic polycarbonate resin.

Furthermore, it is preferred that the polyester-based resin is a polyester-based copolymer; that the polyester-based resin is a resin mainly including a polybutylene terephthalate component; that the polyester-based resin is a resin including a terephthalic acid component and an isophthalic acid component; and that the matrix resin includes a carbodiimide

In addition, it is preferred that the press molding is cold pressing in which a die temperature is 170° C. or lower; and that a temperature of the fiber matrix structure at the time of the press molding is a melting point of the matrix resin or higher, and moreover, it is preferred that preliminary press molding is performed in advance prior to the cold pressing.

Then, it is preferred that the reinforcing fibers are carbon fibers; that the reinforcing fibers are fibers mainly including discontinuous fibers; and that a part of the reinforcing fibers is a unidirectional fiber sheet, and furthermore, it is preferred that the discontinuous fibers are randomly oriented in the structure.

In addition, it is preferred that the matrix resin before the press molding is in a granular or film-like form.

A composite material of another aspect of the present invention is a composite material resulting from the method for manufacturing a composite material according to the present invention as described above.

### Effect of Invention

According to the present invention, a method for manufacturing a composite material including fibers and a resin, which has high high-temperature physical properties and ensures a smooth surface appearance, is provided.

### EMBODIMENTS FOR CARRYING OUT INVENTION

In a method for manufacturing a composite material according to the present invention, it is essential to perform press molding a fiber matrix structure including reinforcing fibers and a matrix resin which mainly includes a polyester-based resin and includes an aromatic polycarbonate resin.

Here, in the present invention, it is necessary that the resin which is used for the matrix is a resin mainly including a polyester-based resin and including an aromatic polycarbonate resin. Here, in the case of using a polycarbonate resin or a polyester resin solely, moldability between the matrix resin and the reinforcing fibers in the composite material is poor at the time of press working, and thus, a uniform composite material may not be obtained. It may be considered that a crystallization temperature of such a resin is too high. However, in the case of using a resin having a low crystallization temperature, even if the reinforcing fibers are used, physical properties of the resulting composite material, such as heat resistance, are lowered. Then, in the manufacturing method of the present invention, when a resin mainly including a polyester-based resin and including an aromatic polycarbonate resin is used for the matrix resin, it becomes possible to make a variety of physical properties compatible with one another.

A content of the aromatic polycarbonate in the matrix resin is smaller than the amount of the polyester resin as the main component, and furthermore, it is preferably from 10 to 45% by weight of the matrix resin component. When the aromatic polycarbonate that is hardly crystallized and amorphous is added in the foregoing content to the polyester resin which is easily crystallized as the main component, in spite of a base material having excellent moldability, a composite material that is excellent in not only physical properties but also surface appearance may be obtained.

Examples of the aromatic polycarbonate resin which is used in the present invention may include a product resulting from a reaction between a divalent phenol and a carbonate precursor. It is possible to obtain such an aromatic polycarbonate resin by a reaction method, such as an interfacial polymerization method, a melt ester interchange method, a solid phase ester interchange method of carbonate prepolymer, and a ring-opening polymerization method of cyclic carbonate compound.

Representative examples of the divalent phenol which is used for such a method include hydroquinone, resorcinol, 4,4′ -biphenol, 1,1-bis(4-hydroxyphenyl)ethane, 2,2-bis(4-hydroxyphenyl)propane (generally called bisphenol A), 2,2-bis(4-hydroxy-3-methylphenyl)propane, 2,2-bis(4-hydroxyphenyl)butane, 1,1-bis(4-hydroxypheny0-1-phenylethane, 1,1-bis(4-hydroxyphenyl)cyclohexane, 1,1-bis(4-hydroxypheny0-3,3,5-trimethylcyclohexane, 2,2-bis(4-hydroxyphenyl)pentane, 4,4′-(p-phenylenediisopropylidene)diphenol, 4,4′-(m-phenylenediisopropylidene)diphenol, 1,1-bis(4-hydroxyphenyl)-4-isopropylcyclohexane, bis(4-hydroxyphenyl) oxide, bis(4-hydroxyphenyl) sulfide, bis(4-hydroxyphenyl) sulfoxide, bis(4-hydroxyphenyl) sulfone, bis(4-hydroxyphenyl) ketone, bis(4-hydroxyphenyl) ester, bis(4-hydroxy-3-methylphenyl) sulfide, 9,9-bis(4-hydroxyphenyl) fluorenone, 9,9-bis(4-hydroxy-3-methylphenyl) fluorenone, and the like. The divalent phenol is preferably a bis(4-hydroxyphenyl)alkane, and above all, bisphenol A (hereinafter sometimes abbreviated as “BPA”) is especially preferred and used for various purposes from the standpoint of impact resistance.

In addition, the polycarbonate resin may be a resin including a polycarbonate-polydiorganosiloxane copolymer resin which includes an organosiloxane block.

A molecular weight of the aromatic polycarbonate resin is not specified; however, when the molecular weight is less than 10,000, the strength or the like is lowered, whereas when it is more than 50,000, the molding workability is lowered, and thus, the molecular weight is preferably from 10,000 to 50,000, more preferably from 12,000 to 40,000, and still more preferably from 15,000 to 35,000 in terms of a viscosity average molecular weight. In addition, the aromatic polycarbonate resin may be used in admixture of two or more kinds thereof. In this case, it is also possible to mix an aromatic polycarbonate resin whose viscosity average molecular weight falls outside the foregoing range.

Then, in the present invention, the polyester-based resin is used as the main component of the matrix resin together with the aromatic polycarbonate resin as described above. Furthermore, this polyester-based resin is preferably a copolymer.

In addition, the polyester-based resin which is used for the matrix in the present invention is preferably a polymer or a copolymer resulting from a condensation reaction between an aromatic dicarboxylic acid or a reactive derivative thereof and a diol or an ester derivative thereof as main components.

As the aromatic dicarboxylic acid as referred to herein, a compound selected from aromatic dicarboxylic acids such as terephthalic acid, isophthalic acid, orthophthalic acid, 1,5-naphthalenedicarboxylic acid, 2,6-naphthalenedicarboxylic acid, 4,4′-biphenyldicarboxylic acid, 4,4′-biphenyl ether dicarboxylic acid, 4,4′-biphenylmethane dicarboxylic acid, 4,4′-biphenylsulfone dicarboxylic acid, 4,4′-biphenylisopropylidene dicarboxylic acid, 1,2-bis(phenoxy)ethane-4,4′-dicarboxylic acid, 2,5-anthracenedicarboxylic acid, 2,6-anthracenedicarboxylic acid, 4,4′-p-terphenylene dicarboxylic acid, and 2,5-pyridinedicarboxylic acid; diphenylmethane dicarboxylic acid, diphenyl ether dicarboxylic acid, and β-hydroxyethoxybenzoic acid is suitably used, and particularly, terephthalic acid, isophthalic acid, and 2,6-naphthalenedicarboxylic acid may be preferably used. The aromatic dicarboxylic acid may be used in admixture of two or more kinds thereof. Incidentally, it is also possible to mix and use at least one compound of aliphatic dicarboxylic acids such as adipic acid, azelaic acid, sebacic acid, and dodecane diacid and alicyclic dicarboxylic acids such as cyclohexanedicarboxylic acid, together with the foregoing dicarboxylic acid so long as an amount thereof is small.

In addition, examples of the diol which is used for a component of the polyester resin include aliphatic diols, such as ethylene glycol, propylene glycol, butylene glycol (1,4-butanediol), hexylene glycol, neopentyl glycol, pentamethylene glycol, hexamethylene glycol, decamethylene glycol, 2-methyl-1,3-propanediol, diethylene glycol, and triethylene glycol; alicyclic diols, such as 1,4-cyclohexanedimethanol; diols containing an aromatic ring, such as 2,2-bis(β-hydroxyethoxyphenyl)propane; and mixtures thereof; and the like. Furthermore, at least one long-chain diol having a molecular weight of from 400 to 6,000, namely polyethylene glycol, poly-1,3-propylene glycol, polytetramethylene glycol, or the like, may be copolymerized, so long as an amount thereof is small.

Then, the polyester-based resin which is used in the present invention is preferably a polyester-based copolymer, and preferably a resin in which the aromatic dicarboxylic acid component or the diol component is constituted of two or more components. For example, it is preferred that the aromatic dicarboxylic acid component is one containing a terephthalic acid component and an isophthalic acid component; or that the diol component is one containing 1,4-butanediol and ethylene glycol.

More specifically, when a preferred polyester copolymer is exemplified, a copolymerization polyester resin such as polyethylene isophthate/terephthalate and polybutylene terephthalaate/isophthate is particularly preferred.

In particular, from the standpoints of physical properties and moldability thereof, the polyester-based resin which is preferably one mainly including a polybutylene terephthalate component. The polyester-based resin is more preferably a polybutylene terephthalate/isophthalate copolymer, and most preferably a copolymer of terephthalic acid and isophthalic acid with 1,4-butanediol. More specifically, the polyester-based resin is preferably one resulting from polycondensation of terephthalic acid or an ester-forming derivative thereof and isophthalic acid or an ester-forming derivative thereof with 1,4-butanediol or an ester-forming derivative thereof by a generally known method.

Furthermore, a content of the isophthalic acid component (hereinafter referred to as “isophthalic acid content”) in the whole of the dicarboxylic acid components in the above-described terephthalate/isophthalate copolymer is preferably from 2 to 50 mol %. More preferably, taking into consideration a balance between the moldability and the physical properties, the isophthalic acid content is preferably 30 mol % or less, and more preferably in the range of from 5 to 20 mol %. When the isophthalic acid content is too low, the moldability tends to be lowered, whereas it is too high, the physical properties or heat resistance tends to be lowered.

Then, the polyester-based resin which is most preferably used in the present invention is a polybutylene terephthalate-based resin. This may be only the polybutylene terephthalate/isophthalate copolymer as described above, or may be a mixture of a polybutylene terephthalate resin and a polybutylene terephthalate/isophthalate copolymer, and a mixture of two kinds of polybutylene terephthalate/isophthalate copolymers having a different isophthalic acid content from each other may also be used. In all of these cases, it is preferred that the isophthalic acid content in the component is in the same range as that in the isophthalic acid content of the terephthalate/isophthalate copolymer as described above.

In the present invention, since the aromatic polycarbonate resin and the polyester-based resin are jointly used as the matrix resin, in addition of an enhancement of the moldability, the surface appearance of the resulting composite material is enhanced. Furthermore, it is preferred from the viewpoint of an enhancement of the surface appearance the polyester-based resin is a copolymerization resin, and especially, the aromatic dicarboxylic acid component is one containing a terephthalic acid component and an isophthalic acid component.

Although an intrinsic viscosity of the polyester resin which is used in the present invention is not particularly limited, in general, the intrinsic viscosity is preferably from 0.50 to 1.50. Incidentally, this intrinsic viscosity is one as measured at 35° C. by using a mixed solvent of phenol and trichloroethylene (phenol/trichloroethylene=60/40). The intrinsic viscosity is more preferably in the range of from 0.60 to 1.40, and the intrinsic viscosity is especially preferably in the range of from 0.70 to 1.35.

In addition, a terminal group structure of the polyester-based resin which is used in the present invention is not particularly limited, and in addition to the case where proportions of a hydroxyl group and a carboxyl group in the terminal group are substantially the same amount, the case where the proportion of one side is larger may be adopted. In addition, the terminal groups may also be sealed by, for example, allowing a compound having reactivity with those terminal groups to react.

Such a polyester-based resin may be produced by polymerizing the dicarboxylic acid component and the above-described diol component in the presence of a specified titanium-based catalyst while heating and discharging water or a lower alcohol formed as a by-product outside the system, according to the ordinary way.

Furthermore, it is also preferred to jointly use an elastomer in the matrix resin which is used in the present invention. By jointly using the elastomer, the matrix resin becomes soft, and the moldability at the time of press molding is enhanced. In addition, physical properties of the final composite material, such as heat resistance, may be enhanced. As the elastomer which may be used, a thermoplastic resin elastomer is preferred, and an acrylic elastomer or a polyester-based elastomer is more preferred.

In addition, though the matrix resin of the present invention includes the polyester resinthe aromatic polycarbonate resin and the polyester resin as described above, it is preferred to further add at least one compound selected from carbodiimide compounds, acrylic compounds, epoxy compounds, and oxazoline compound. In the case of adding such a compound, the terminal of a polymer constituting the matrix resin is blocked, and the physical properties of a finally obtained fiber resin composite body are enhanced.

In addition, it is also preferred that in addition to the reinforcing fibers, an inorganic filler is compounded in this matrix resin. Examples of the inorganic filler may include talc, calcium silicate, wollastonite, montmorillonite, and various inorganic fillers. In addition, if desired, other additives which have hitherto been compounded in matrix resins, such as a heat-resistant stabilizer, an antistatic agent, a weather-resistant stabilizer, a light-resistant stabilizer, an anti-aging agent, an antioxidant, a softening agent, a dispersant, a filler, a colorant, and a lubricant, may be compounded in the above-described matrix resin.

In the manufacturing method of the present invention, it is essential to use reinforcing fibers together with the matrix resin as described above. The reinforcing fibers as used herein have only to be a fibrous material capable of reinforcing the matrix of the composite body, and inorganic fibers, such as carbon fibers with high strength and glass fibers, or organic synthetic fibers such as aromatic polyamide fibers, may be used. Above all, in order to obtain a composite body with high rigidity, more specifically, it is possible to exemplify carbon fibers such as polyacrylonitrile (PAN)-based carbon fibers, petroleum or coal pitch-based carbon fibers, rayon-based carbon fibers, and lignin-based carbon fibers. In particular, PAN-based carbon fibers made of PAN as a raw material are preferred because of excellent productivity on an industrial scale and mechanical properties.

As for a tex of the reinforcing fibers, it is suitable to use those having an average diameter of preferably from 3 to 12 μm, and more preferably from 5 to 10 μm. Within the foregoing range, not only the physical properties of the fibers are high, but also the dispersibility in the matrix is excellent. In addition, by making the tex of the reinforcing fibers small, it becomes possible to render the surface state of the composite body after press molding more smooth. In addition, the reinforcing fibers are preferably a fiber bundle of from 1,000 to 50,000 monofilaments from the standpoint of productivity. Furthermore, the number of monofilaments constituting the fiber bundle is preferably in the range of from 3,000 to 40,000, and more preferably in the range of from 5,000 to 30,000.

In addition, for the purpose of reinforcing the resin, it is preferred that the strength of the fibers which are used for the composite body is higher, and it is preferred that the fibers has a tensile strength of form 3,500 MPa to 7,000 MPa and a modulus of from 220 GPa to 900 GPa. In that sense, from the viewpoint that a molded article with high strength is obtained, the fibers are preferably carbon fibers, and more preferably PAN-based carbon fibers.

As for a form of these fibers in the composite body, it is possible to use the fibers in a long-fiber or short-fiber form. However, from the viewpoint of reinforcing the resin, fibers having a long-fiber shape are preferred; and conversely, from the viewpoint that the physical properties of the composite body become isotropic such that anisotropy is hardly generated, a structural element mainly including short fibers is preferred. Here, the short fibers may be discontinuous fibers that are not long fibers. When used as short fibers, it is preferred to use the fibers as a fiber aggregate or non-woven fabric in which the fibers are randomly oriented in advance. In the case where the fibers are a long fiber, the fibers may be used in various forms such as a unidirectional sheet, a textile, a knitted goods, and a braid; however, from the standpoint of strength reinforcement of the composite body, it is preferred that the long fibers are partially used as a unidirectional sheet (so-called UD sheet) in the composite body, and a part of the reinforcing fibers is a unidirectional fiber sheet. As a most preferred form, it is preferred that the short fibers (discontinuous fibers) are randomly oriented in the structure, and a part of the reinforcing fibers is a unidirectional fiber sheet. Furthermore, it is also possible to partially use one kind or a combination of two or more kinds as such a fiber form.

In addition, in the case where the reinforcing fibers are short fibers (discontinuous fibers), a length thereof is preferably from 3 mm to 100 mm The length is more preferably from 15 to 80 mm, and most preferably from 20 to 60 m. In addition, in the case where the reinforcing fibers are used in a form such as a sheet-like form of non-woven fabric in advance, the reinforcing fibers are preferably a random mat in which discontinuous fibers having a fiber length of from 3 mm to 100 mm are randomly oriented. Furthermore, the reinforcing fibers are preferably in a form of a random mat in which discontinuous fibers are oriented substantially two-dimensionally randomly. By using a random mat, it becomes possible to obtain an isotropic composite material. Furthermore, when such disposition is taken, not only the strength and anisotropy to the dimensions are improved, but also the strength reinforcement due to the fibers are more efficiently exhibited. Incidentally, though the random mat referred to herein may be constituted of only carbon fibers, a resin working as the matrix may be intermingled as described later.

In addition, it is preferred to use reinforcing fibers, to surfaces of which a sizing agent has been attached prior to forming a structure with the matrix. As the sizing agent, epoxy-based or polyester-based sizing agents and the like may be used, and as for an attachment quantity thereof, the sizing agent is attached in an attachment quantity of preferably from 0 to 10 parts by weight, and more preferably from 0.2 to 2 parts by weight in terms of a dry weight based on 100 parts by weight of the fibers.

In addition, in company with giving the sizing agent, it is also preferred to separately subject the surfaces of the fibers to a surface treatment, whereby an effect for an enhancement of adhesiveness or the like may be obtained. For example, in the case of using carbon fibers as the reinforcing fibers, a liquid phase or vapor phase treatment or the like is preferably adopted, and particularly it is preferred to perform a liquid phase electrolysis surface treatment from the standpoints of productivity, stability, costs, and the like.

By giving the sizing agent to the reinforcing fibers or subjecting the reinforcing fibers to a surface treatment, not only handling properties or bundling properties may be improved especially when used as a reinforcing fiber bundle, but also adhesiveness or affinity between the reinforcing fibers and the matrix resin may be enhanced.

The method for manufacturing a composite material according to the present invention is a manufacturing method in which it is essential to form a fiber matrix structure from the reinforcing fibers and the matrix resin mainly including a polyester-based resin and including an aromatic polycarbonate resin as described above, followed by press molding.

As for the fiber matrix structure, it is preferred that the resin working as the matrix is in a granular or film-like form prior to the pressing step at the beginning. More specifically, especially in the case where the reinforcing fibers are short fibers (discontinuous fibers), it is preferred to prepare a structure by using a mixture including such reinforcing short fibers and the polyester-based resin having a granular or film-like shape. Incidentally, here, in the case where the resin is a granular material, it may take every form such as a fibrous form, a powdery form, and a needle-like form. In addition, it is preferred that the reinforcing fibers are in a fiber bundle shape from the standpoints of production efficiency and physical properties thereof.

Suitable examples of the fiber matrix structure using such reinforcing fibers may include the following random mat.

An average fiber length of the reinforcing fibers to be used for the random mat is preferably in the range of from 3 to 100 mm, more preferably in the range of from 15 to 80 mm, and most preferably in the range of from 20 to 60 mm, and the reinforcing fibers may be formed using one or a combination of two or more kinds of these fiber lengths.

In order to randomly dispose the reinforcing fibers, the fiber bundle is preferably one resulting from opening. The random mat is preferably one constituted of the fiber bundle made of short fibers and the polyester-based resin, in which the fibers are oriented in-plane randomly.

As for an existent amount of the fibers in the random mat, when the whole of the composite body is defined as 100, a proportion of the fibers is preferably from 10 to 90% by volume. The proportion of the fibers is more preferably from 15 to 80% by volume, and most preferably from 20 to 60% by volume.

It is possible to produce the random mat using such reinforcing fibers through, for example, the following specific steps.

(1) A step of cutting a reinforcing fiber bundle;

(2) a step of introducing the cut reinforcing fibers into a tube and blowing air onto the fibers, thereby opening the fiber bundle;

(3) an application step of diffusing the opened fibers and simultaneously spraying the fibers and a polyester-based resin at the same time while sucking together with the polyester-based resin; and

(4) a step of fixing the applied fibers and polyester-based resin.

In this process, in the step (3), besides spraying the polyester-based resin at the same time as described above, a step of spraying only the fibers and covering a polyester-based resin film having a thickness of from 10 μm to 300 μm thereon may also be adopted.

In the manufacturing method of the present invention, it is preferred to control a degree of opening of the fibers in the polyester-based resin matrix, thereby making a random mat including fibers existent in a fiber bundle and other opened fibers. By appropriately controlling an opening ratio, a random mat suitable for various applications and purposes may be provided.

The random mat may be obtained by, for example, cutting the fiber bundle and introducing the cut fiber bundles into a tapered tube, followed by blowing by allowing compressed air to flow thereinto. By preparing an appropriate random mat, it becomes possible to bring the fibers and the polyester-based resin into close contact with each other more minutely, thereby attaining high physical properties.

The method for manufacturing a composite material according to the present invention is a method of press molding the fiber matrix structure as described above. Furthermore, cold pressing in which the die temperature in the press molding is 170° C. or lower is preferred. The die temperature is especially preferably in the range of from 90° C. to 160° C. By performing the pressing at such a low temperature, it becomes possible to take away a product from the die simultaneously with completion of molding, and it becomes possible to secure high productivity. In general, the reinforcing fibers hardly flow in the press working under such a condition; however, according to the manufacturing method of the present invention, by using a polyester-based resin having a low crystallization temperature, it has become possible to obtain a composite body which has excellent moldability and in spite of high efficiency, has excellent physical properties.

In addition, it is preferred that the fiber matrix structure at the time of press molding is preheated in advance, and a temperature of the structure at that time is preferably a melting point thereof or higher. An upper limit thereof is preferably a temperature within 150° C. higher than the melting point. The temperature is more preferably within the range of from 20° C. to 100° C. higher than the melting point. A specific temperature is preferably in the range of from 220° C. to 320° C., and more preferably in the range of from 260° C. to 300° C. By preheating the fiber matrix structure in this way, it becomes possible to effectively perform the cold pressing.

In the method for manufacturing a composite material according to the present invention, the shape of the fiber matrix structure prior to pressing is preferably in a plate-like or sheet-like form in which the fiber matrix structure is easily made uniform. According to the manufacturing method of the present invention, in spite of the structure including fibers and a resin, a degree of freedom of the form at the time of press molding is high, and by using such a fiber matrix structure in a sheet-like form, it becomes possible to perform press molding in various shapes. In particular, the fiber matrix structure in a sheet-like form is optimally used for a shape having a bending part.

In addition, from the viewpoint of securing the degree of freedom of the working steps, it is preferred to perform preliminary press molding at a temperature of the melting point of the matrix resin or higher in advance prior to cold pressing. After the preliminary press molding, the plate-like shape is kept even at the time of movement, and thus, even in the case of adopting any step layout, it becomes possible to undergo stable production. An intermediate (composite body) having been subjected to such preliminary pressing is especially useful as an interim base material for cold pressing. For example, by superimposing two or more sheets of thin interim base materials and subjecting the plural sheets to cold pressing all at one, it becomes possible to produce composite materials having various shapes with ease.

Indeed, in order to increase the production efficiency, it is preferred to perform the method for manufacturing a composite material according to the present invention by a continued one step, and in that case, it is preferred to adopt a method of subjecting the fiber matrix structure in a sheet-like form directly to cold pressing without performing the preliminary pressing step.

According to the manufacturing method of the present invention, by performing the cold pressing as described above, it has become possible to secure high productivity. Incidentally, in general, the polyester-based resin that is a main component of the matrix resin is high in crystallinity, is hardly molded, and is required to perform molding at a high pressing temperature while taking the time, and its productivity was low. However, according to the present invention, by containing the aromatic polycarbonate resin in the matrix resin, it has become possible to perform press molding with high efficiency.

In addition, astonishingly, in spite of using the resin of a multi-component system in this way, in which the physical properties are generally lowered, according to the manufacturing method of the present invention, it has become possible to secure physical properties, such as heat resistance, substantially equal to those of a polyester-based resin alone. This is especially remarkable in the case of using carbon fibers as a random mat for reinforcing fibers, and it may be considered that the presence of the reinforcing fibers which are randomly but uniformly dispersed as a whole greatly contributes to this matter.

In addition, in the manufacturing method of the present invention, though it is preferred that the discontinuous fibers are randomly oriented in the fiber matrix structure, it is more preferred that a part of the reinforcing fibers is a unidirectional fiber sheet. By disposing such a unidirectional fiber sheet in, for example, a portion with weak strength or a portion forming a corner in a final molded body and performing press molding, as compared with the case of using only a random mat, it becomes possible to prepare a molded article with higher strength.

The shape of a final molded article using the composite material obtained in the present invention is preferably a cylindrical or prismatic shape in addition to a simple plate-like shape. In addition, it is also preferred to adopt a shape so as to form a cylindrical or prismatic shape by plural parts. According to the composite material of the present invention, in spite of the polyester-based resin reinforced with fibers, the degree of freedom for imparting a shape at the time of press molding, and it becomes possible to provide a deep-drawn product thereof.

The composite material obtained by the manufacturing method of the present invention or the molded article using the same is a composite material which is excellent in chemical resistance and excellent in durability against not only acids and alkalis but also metal chlorides, such as calcium chloride and zinc chloride, and it becomes possible to use the composite material for various applications. It is also possible to use the composite material of the present invention as a composite material to be used under severe conditions as in, for example, vehicle body structures or outdoor structures.

Furthermore, the composite material obtained by the manufacturing method of the present invention is constituted of the matrix resin with excellent physical properties and the reinforcing fibers, and after integrating by press molding, the resultant becomes a material satisfying not only an extremely high surface appearance (gloss) but also high physical properties, especially physical properties at high temperatures. Then, such a composite material is excellent in design properties and may be optimally used especially in a part which a person directly touches, such as automobile interior materials.

### Examples

The present invention is hereunder explained in more detail by reference to Examples, but it should not be construed that the present invention is limited to the following Examples. Incidentally, the Examples of the present invention were evaluated by the following methods.

<Measurement of rate of Impregnation>

First of all, 15 g of a matrix resin for impregnation was put into a silicon rubber-made mold which had been cut out a pattern of 10×10×2 mm and subjected to heat press molding at a preset temperature of 250° C., thereby preparing a resin sheet having a thickness of 2 mm

Meanwhile, a carbon fiber mat having a thickness of about 0.33 mm in an unmolded state was obtained by using a carbon fiber strand (“TENAX STS-24K N00”, manufactured by Toho Tenax Co., Ltd., 7 μm (diameter)×24,000 filaments) which had been cut in a size of 20 mm Then, this carbon fiber mat was cut out in a size of 10 cm×10 cm, six sheets were stacked to form a stacked mat having a thickness of about 2 mm and a weight of about 12 g, and the weight was precisely measured.

The above-described resin sheet was superimposed on the resulting stacked mat, and the resultant was heated and pressurized by a hot press at a press pressure of 65 kgf and a press temperature of 300° C. for 3 minutes, thereby preparing a carbon fiber mat in which the resin was partially impregnated.

The carbon fibers in which the resin was not impregnated were removed, and a rate of impregnation of the matrix resin relative to the carbon fiber mat was calculated according to the following equation.

Rate of impregnation (%)=[(weight of initial stacked mat)−(weight of removed carbon fibers)]/(weight of initial stacked mat)

<Die Filling Ratio>

For preliminary pressing, an interim base material including reinforcing fibers and a matrix resin and having a length of 195 mm, a width of 95 mm, and a thickness of 2 mm was prepared under a temperature condition at 260° C. Subsequently, this interim base material was preheated such that its temperature reached 300° C. and then subjected to cold pressing in a die having a length of 230 mm, a width of 100 mm, and a thickness of 1.6 mm at a temperature of 130° C. In the case where the interim base material was filled entirely in the die for cold pressing, the die filling ratio is defined as 100%, and in the case where the area of the interim base material did not change, the die filling ratio is defined as 0%, thereby evaluating cold pressing moldability.

<Physical Properties of Base Material>

As for physical properties of the composite material, a specimen having a shape of 250×25 mm was prepared. Using this specimen, tensile strength and flexural strength were measured in conformity with JIS K7164. Flexural strength was measured in conformity with JIS K7074. Incidentally, as for the measurement temperature, the measurement was performed at 23° C. as a typical condition and at 80° C. as a high-temperature condition, respectively.

<Surface Gloss>

A flat board of 10 cm×10 cm was cut out from the above-described interim base material, thereby preparing a measuring sample. Surface gloss was measured in conformity with JIS Z8741. Incidentally, the measurement was performed at a light incidence angle of 60°.

### Example 1

As the polyester-based resin in the matrix resin component, a polybutylene terephthalate/isophthalate copolymer (hereinafter referred to as “PBT/IA copolymer”) having a ratio of terephthalic acid to isophthalic acid of 80/20 mol % was prepared. This had a melting point of 193° C. and an intrinsic viscosity of 1.02. 80% by weight of this polyester-based resin was compounded with 20% by weight of an aromatic polycarbonate resin (“PANLITE L-1250Y”, manufactured by Teijin Chemical Ltd.) by using a twin-screw melt kneader, thereby preparing a matrix resin.

Meanwhile, a carbon fiber bundle (a carbon fiber strand, “TENAX STS-24K N00”, manufactured by Toho Tenax Co., Ltd., 7 um (diameter)×24,000 filaments, tex: 1.6 g/m, tensile strength: 4,000 MPa (408 kg f/mm²), tensile modulus: 238 GPa (24.3 tons/mm²)) as reinforcing fibers was continuously dipped in an epoxy-based sizing agent, allowed to pass through a drying furnace at 130° C. for about 120 seconds, and then dried and heated, thereby preparing a carbon fiber bundle having a width of about 12 mm At this time, an attachment quantity of the sizing agent to the carbon fiber bundle was 1% by weight.

Using such matrix resin and reinforcing fibers, a random mat was prepared. As reinforcing resins, those obtained by cutting the above-described carbon fiber bundle in a size of 20 mm were used, and as a matrix resin, a powder having an average particle diameter of about 1 mm, which was obtained by pulverizing the material as described above and further classifying with 20 mesh and 30 mesh, was used.

First of all, the reinforcing fibers and the matrix resin powder (pulverized product) were introduced into a tapered tube, and air was blown into the carbon fibers, thereby spraying the carbon fibers together with the matrix resin powder onto a table placed in a lower part of an outlet of the tapered tube while partially opening the fiber bundle. The sprayed carbon fibers and matrix resin pulverized product were sucked by a blower from a lower part of the table and immobilized, thereby obtaining a carbon fiber random mat having a thickness of about 5 mm.

The resulting carbon fiber random mat was subjected to a preliminary pressing step using a pressing apparatus heated at 260° C., thereby obtaining an interim base material (composite material) having a fiber volume fraction (Vf) of 35 vol %.

The physical properties of the resulting interim base material were 340 MPa at ordinary temperature and 270 MPa in an atmosphere at 80° C., respectively. As a result of measuring the flexural strength, it was 280 MPa at ordinary temperature. In addition, the interim base material was cut out into a flat board of 10 cm×10 cm and measured for surface gloss. The surface gloss was 60. In addition, the resultant was a composite body free from a lowering in the physical properties by cold pressing and having high durability against all of chemicals including acids, alkalis, and calcium chloride.

The obtained physical properties are shown in Table 1.

### Example 2

An interim base material and a composite body having been subjected to cold pressing were obtained in the same manners as those in Example 1, except that in Example 1, the content of the aromatic polycarbonate resin in the matrix resin was changed from 20% by weight to 40% by weight. A rate of impregnation of this matrix resin into the carbon fiber mat was so excellent as 74%. The results are also shown in Table 1.

### Example 3

An interim base material in which the content of the aromatic polycarbonate resin was 40% by weight and a composite body having been subjected to cold pressing were obtained in the same manners as those in Example 2, except that a PBT/IA copolymer having a ratio of terephthalic acid to isophthalic acid of 90/10 mol % was used as the polyester-based resin in the matrix resin in place of the polyester-based resin having a content of isophthalic acid of 20 mol % as used in Examples 1 and 2. The results are also shown in Table 1.

### Example 4

An interim base material and a composite body having been subjected to cold pressing were obtained in the same manners as those in Example 1, except that a carbodiimide (“Stabaxol P”, manufactured by Rhein Chemie Japan Ltd.) was added as a third component of the matrix resin.

As a result of measuring the humidity resistance (holding ratio of intrinsic viscosity) of the matrix resin thereof, it was 95%, a value of which was conspicuously enhanced as compared with 50% in Example 1. Here, the humidity resistance is one resulting from performing an acceleration test using a pressure cooker tester and comparing the measured value (intrinsic viscosity) before and after the treatment. As for an acceleration test condition, the test was performed under a condition at 120° C. and 100% RH for 48 hours.

The results are also shown in Table 1.

### Comparative Example 1

An interim base material and a composite body having been subjected to cold pressing were obtained in the same manners as those in Example 1, except that in Example 1, the content of the aromatic polycarbonate resin in the matrix resin was changed from 20% by weight to none (0% by weight). Although the die filling ratio, the physical properties, and the like were excellent, in particular, the surface gloss was low, and the appearance was inferior. The results are also shown in Table 1.

### Comparative Example 2

An interim base material and a composite body having been subjected to cold pressing were obtained in the same manners as those in Example 1, except that 90% by weight of the polyester-based resin having a ratio of terephthalic acid to isophthalic acid of 80/20 mol% as used in Example 1 or Comparative Example 1 was used as the polyester-based resin in the matrix resin, that 10 parts by weight of a polyester elastomer (“HYTREL 4767”, manufactured by Du Pont-Toray Co., Ltd.) was used for the balance of the remaining 10% by weight, and that the aromatic polycarbonate resin was not used. That is, this is corresponding to an elastomer additional content fraction of Comparative Example 1 as described above. Since this uses an elastomer, though the surface glass was excellent as compared with Comparative Example 1, the high-temperature physical properties at 80° C. were more lowered than those in Comparative Example 1. The results are also shown in Table 1.

### Comparative Example 3

An interim base material and a composite body having been subjected to cold pressing were obtained in the same manners as those in Example 1, except that similar to Comparative Example 1, the content of the aromatic polycarbonate resin in the matrix resin was changed to none (0% by weight), and that a resin having a ratio of terephthalic acid to isophthalic acid of 100/0 mol % was used as the polyester-based resin in the matrix resin in place of the copolymer resin in Example 1. Although this was slightly enhanced in the high-temperature physical properties as compared with Comparative Example 1, its surface gloss was lowered, and in the final analysis, it was inferior in all of the high-temperature physical properties at 80° C. and the surface gloss as compared with Example 1.

The results are also shown in Table 1.

### Example 5

On the interim base material including reinforcing fibers and a matrix resin as obtained in Example 1, a unidirectional sheet (UD sheet) including unidirectionally paralleled carbon fibers and the same matrix resin as that used in the interim base material in Example 1 as described above were superimposed, and the resultant was subjected to cold pressing under the same condition as that in Example 1, thereby obtaining a composite material having a two-layer structure of the random web and the unidirectional sheet. There was obtained the composite material with more enhanced strength.

TABLE 1

| | | | | | Comparative | Comparative | Comparative |
|---|---|---|---|---|---|---|---|
| | Example 1 | Example 2 | Example 3 | Example 4 | Example 1 | Example 2 | Example 3 |
| Reinforcing fibers | Carbon | Carbon | Carbon | Carbon | Carbon | Carbon | Carbon |
| | fibers | fibers | fibers | fibers | fibers | fibers | fibers |
| PES/PC ratio | 80/20 | 60/40 | 60/40 | 79/20 | 100/0 | 90/0 | 100/0 |
| Other component | — | — | — | CI | — | EL | — |
| (Addition part number) | | | | (1) | | (10) | |
| TA/IA content in PES resin | 80/20 | 80/20 | 90/10 | 80/20 | 80/20 | 80/20 | 100/0 |
| Die filling ratio (%) | 100 | 100 | 85 | 85 | 100 | 100 | <30 |
| Physical properties of base material (MPa) | | | | | | | |
| Tensile strength at 23° C. | 340 | 330 | 350 | 340 | 340 | 310 | 350 |
| Tensile strength at 80° C. | 270 | 300 | 315 | 260 | 230 | 210 | 240 |
| Flexural strength at 80° C. | 280 | 330 | 335 | 280 | 240 | 220 | 250 |
| Appearance (surface gloss) | 60 | 80 | 75 | 75 | 40 | 80 | 30 |

PES: Polyester-based resin
PC: Aromatic polycarbonate resin
CI: Carbodiimide
EL: Elastomer

1. A method for manufacturing a composite material comprising performing press molding a fiber matrix structure including reinforcing fibers and a matrix resin which mainly includes a polyester-based resin and which includes an aromatic polycarbonate resin.

2. The method for manufacturing a composite material according to claim 1, wherein the polyester-based resin is a polyester copolymer.

3. The method for manufacturing a composite material according to claim 1, wherein the polyester-based resin mainly includes a polybutylene terephthalate component.

4. The method for manufacturing a composite material according to claim 1, wherein the polyester-based resin is a copolymer resin including a terephthalic acid component and an isophthalic acid component.

5. The method for manufacturing a composite material according to claim 1, wherein the matrix resin includes a carbodiimide.

6. The method for manufacturing a composite material according to claim 1, wherein the press molding is cold pressing in which a die temperature is 170° C. or lower.

7. The method for manufacturing a composite material according to claim 1, wherein a temperature of the fiber matrix structure at the time of the press molding is a melting point of the matrix resin or higher.

8. The method for manufacturing a composite material according to claim 6, wherein preliminary press molding is performed in advance prior to the cold pressing.

9. The method for manufacturing a composite material according to claim 1, wherein the reinforcing fibers are carbon fibers.

10. The method for manufacturing a composite material according to claim 1, wherein the reinforcing fibers are fibers mainly including discontinuous fibers.

11. The method for manufacturing a composite material according to claim 1, wherein a part of the reinforcing fibers is a unidirectional fiber sheet.

12. The method for manufacturing a composite material according to claim 10, wherein the discontinuous fibers are randomly oriented in the structure.

13. The method for manufacturing a composite material according to claim 1, wherein the matrix resin prior to the press molding is in a granular or film-like form.

14. A composite material obtained by a method for manufacturing a composite material according to claim 1.
